(19) United States
(12) Patent Application Publication
(10) Pub. No.: US 2015/0342393 A1
(43) Pub. Date: Dec. 3, 2015

(54) HOT-WATER-ACTUATED ESPRESSO MACHINE

(71) Applicant: Oded LOEBL, Tel Mond (IL)

(72) Inventor: Oded LOEBL, Tel Mond (IL)

(21) Appl. No.: 14/654,533

(22) PCT Filed: Jan. 2, 2014
(86) PCT No.: PCT/IB2014/058019

§ 371 Date: Jun. 21, 2015

Related U.S. Application Data
(60) Provisional application No. 61/748,083, filed on Jan. 1, 2013.

(51) Int. Cl. A47J 31/36

(52) U.S. Cl. CPC A47J 31/36

(57) ABSTRACT

A hot-water-actuated espresso coffee maker has a chamber receiving a quantity of hot water and a piston. An actuator forces the piston through at least part of the chamber so as to deliver hot water under pressure through ground coffee. The actuator includes a shape-memory element configured such that, when a temperature of the element is raised above a transition temperature, the shape-memory element undergoes a phase change so as to become biased towards a predefined spring configuration, thereby applying force to the piston. A flow-guide element helps define a flow path at least partially blocking an inflow of hot water from reaching the shape-memory element until at least a majority of the chamber has been filled. The inflow of hot water sequentially fills the chamber and then heats the shape-memory element above the transition temperature.

### FIELD AND BACKGROUND OF THE INVENTION

The present invention relates to coffee machines and, in particular, it concerns an apparatus receiving an inflow of unpressurized hot water and generating a pressurized flow of a quantity of the hot water through ground coffee.

The conditions required to produce an optimal espresso coffee may be defined as follows: 25-30 cc of espresso coffee are prepared from 7-9 grams of coffee through which purified water at a temperature of 90-94° C. has been forced at a pressure of 9-10 atmospheres, resulting in a brew time of 22-28 seconds. Commercially available coffee makers which can reproduce these conditions in a domestic setting are typically costly and relatively large, whilst many of the more cheaply priced coffee makers fail to generate pressures approaching the range mentioned above.

A prior patent application, published as WO 2011/153272, co-assigned with the present application, discloses various coffee makers in which a shape-memory alloy actuator undergoes a phase transition on heating, undergoing a shape change so as to apply sufficient force on a piston to generate pressure approximating to the desired range. The content of the '272 publication is hereby incorporated in its entirety as providing relevant background to the present invention.

All of the embodiments described in the '272 publication heat water within the coffee maker, either by operation of a built-in heating element or by use on a stovetop.

There is therefore a need for an apparatus that receives an inflow of unpressurized hot water and generates a pressurized flow of a quantity of the hot water through ground coffee, thereby preparing coffee.

### SUMMARY OF THE INVENTION

The present invention is an apparatus that receives an inflow of unpressurized hot water and generates a pressurized flow of a quantity of the hot water through ground coffee to prepare coffee (beverage).

According to the teachings of the present invention there is provided, an apparatus receiving an inflow of unpressurized hot water and generating a pressurized flow of a quantity of the hot water through ground coffee, the apparatus comprising: (a) a chamber for receiving the quantity of hot water; (b) a piston configured to cooperate with the chamber to apply pressure to the quantity of hot water; (c) an actuator arrangement for forcing the piston through at least part of the chamber so as to deliver the quantity of hot water under pressure through the ground coffee, the actuator arrangement comprising at least one shape-memory element formed from shape-memory alloy and configured such that, when a temperature of the shape-memory element is raised above a transition temperature, the shape-memory element undergoes a phase change so as to become biased towards a predefined spring configuration, thereby applying force to the piston; and (d) at least one flow-guide element defining at least part of a flow path for the inflow of unpressurized hot water to the chamber, the flow-guide element at least partially blocking the inflow from reaching the shape-memory element until at least a majority of the chamber has been filled, such that the inflow of hot water is effective to sequentially fill the chamber and then heat the shape-memory element above the transition temperature.

According to a further feature of an embodiment of the present invention, the actuator arrangement includes a housing sealingly connected with the chamber such that, after filling of the chamber, continuing inflow of the hot water increases a water level within the housing until the shape-memory element is at least partially immersed in the hot water.

According to a further feature of an embodiment of the present invention, there is also provided a selectively openable ground-coffee-receiving compartment associated with an end of the chamber, the ground-coffee-receiving compartment being in fluid flow communication with the chamber for receiving the pressurized flow of the quantity of hot water.

According to a further feature of an embodiment of the present invention, there is also provided a plunger sized and shaped such that, after operation of the apparatus, when the shape-memory element has cooled below the transition temperature and when the ground-coffee-receiving compartment is opened, forced insertion of the plunger to the chamber is effective to return the shape-memory element to an initial form.

According to a further feature of an embodiment of the present invention, the predefined spring configuration of the shape-memory element is a helical spring form, and wherein, in an initial form of the shape-memory element prior to the phase change, the helical spring form is axially compressed, the flow-guide element at least partially defining a flow path passing within the axially compressed helical form.

According to a further feature of an embodiment of the present invention, the piston has an elongated body including the flow-guide element implemented as a wall circumscribing at least part of the flow path.

According to a further feature of an embodiment of the present invention, the piston has a seal for sealing in sliding contact with a cylindrical surface of the chamber, and wherein the flow path through the body terminates in at least one opening adjacent to the seal.

According to a further feature of an embodiment of the present invention, the chamber is partly defined by a cylindrical wall against which the piston is slidingly engaged, and wherein a first region of the cylindrical wall is provided with at least one bypass flow-channel configured such that, when the piston is engaged with the cylindrical wall in an initial position, the bypass flow-channel provides part of the flow path bypassing the piston for inflow of the hot water into the chamber.

According to a further feature of an embodiment of the present invention, there is also provided a resilient obstruction associated with the piston and with a housing of the actuator arrangement, the resilient obstruction being deployed to prevent motion of the piston relative to the chamber until a force exerted by the actuator arrangement exceeds a predefined force threshold.

According to a further feature of an embodiment of the present invention, the resilient obstruction comprises an elastomeric element deployed adjacent to a restriction such that displacement of the piston relative to the chamber is prevented until the elastomeric element is deformed sufficiently to pass the restriction.

According to a further feature of an embodiment of the present invention, the resilient obstruction comprises at least one spring-mounted bearing assembly.

According to a further feature of an embodiment of the present invention, there is also provided a locking pin engaged with the piston and with a housing of the actuator arrangement so as to prevent motion of the piston relative to the chamber, the locking pin being displaceable to release engagement with one of the piston and the housing to allow motion of the piston relative to the chamber.

According to a further feature of an embodiment of the present invention, there is also provided a shape-memory alloy trigger element associated with the locking pin and configured to displace the looking when the shape-memory alloy trigger is raised above a given trigger temperature.

### BRIEF DESCRIPTION OF THE DRAWINGS

The invention is herein described, by way of example only, with reference to the accompanying drawings, wherein:

FIG. 1 is an isometric view of an apparatus according to an embodiment of the present invention for receiving an inflow of unpressurized hot water and generating a pressurized flow of a quantity of the hot water through ground coffee;

FIG. 2A is a cut-away view of the apparatus of FIG. 1 illustrating a pre-filling state of a piston ready for use;

FIGS. 2B and 2C are views similar to FIG. 2A illustrating subsequent positions of the piston during operation of the apparatus;

FIGS. 3A and 3B are enlarged views of the regions of FIGS. 2A and 2B, respectively, designated “III”;

FIGS. 4A-4C are cut-away views of a further apparatus according to an embodiment of the present invention, showing a pre-filling state of a piston and two subsequent positions during motion of the piston, respectively;

FIG. 5 is an enlarged, partial, cut-away view of the initial state of FIG. 4A cut along a plane chosen to illustrate bypass flow channels for allowing flow past the piston;

FIGS. 6A and 6B illustrate the apparatus of FIG. 4A shown, respectively, in a final position at the end of use and after use of a plunger to reset the apparatus for a subsequent use;

FIG. 7 is a cut-away view of an apparatus according to a further embodiment of the present invention;

FIG. 8 is a cut-away view of an apparatus according to a further embodiment of the present invention employing a removable funnel;

FIG. 9 is a cut-away view of an apparatus according to a further embodiment of the present invention employing hall plunger retaining elements;

FIGS. 10A and 10B are enlarged partial views of the region of FIG. 9 designated “X” illustrating, respectively, an initial position of the piston and a displaced position after release from the retaining elements;

FIG. 11 is a cut-away view of an apparatus according to a further embodiment of the present invention employing ball plunger retaining elements in an alternative configuration;

FIGS. 12A and 12B are enlarged partial views of the region of FIG. 11 designated “XII” illustrating, respectively, an initial position of the piston and a displaced position after release from the retaining elements;

FIG. 13 is a cut-away view of an apparatus according to a further embodiment of the present invention illustrating an alternative implementation of a retaining mechanism based on a resilient obstruction;

FIG. 14 is an enlarged view of a region of FIG. 13 designated “XIV”;

FIGS. 15A and 15B are views similar to FIG. 14 illustrating, respectively, two subsequent positions of the piston;

FIG. 16 is a cut-away view of an apparatus according to a further embodiment of the present invention illustrating a further alternative implementation of a retaining mechanism based on a locking pin;

FIGS. 17A, 17B and 17C are enlarged partial views of FIG. 16 illustrating, respectively, a locked state of the locking pin, a released state of the locking pin prior to piston motion, and a subsequent position of the piston; and

FIGS. 18A-18C are cut-away views of an apparatus according to a still further embodiment of the present invention employing a stop valve, the apparatus being shown during a first stage of filling, a second stage of filling, and at the end of the piston motion, respectively.

### DESCRIPTION OF THE PREFERRED EMBODIMENTS

The present invention is an apparatus that receives an inflow of unpressurized hot water and generates a pressurized flow of a quantity of the hot water through ground coffee to prepare coffee (beverage), and a corresponding method.

The principles and operation of an apparatus according to the present invention may be better understood with reference to the drawings and the accompanying description.

Referring now to the drawings, FIGS. 1-3B illustrate an apparatus, generally designated 10, constructed and operative according to a first embodiment of the present invention, for receiving an inflow of unpressurized hot water and generating a pressurized flow of a quantity of the hot water through ground coffee. In general terms generic to this and all embodiments described herein, apparatus 10 has a chamber 12 for receiving the quantity of hot water, a piston 14 configured to cooperate with chamber 12 to apply pressure to the quantity of hot water, and an actuator arrangement for forcing piston 14 through at least part of chamber 12 so as to deliver the quantity of hot water under pressure through the ground coffee, typically located in an adjoining ground-coffee-receiving compartment 18.

The actuator arrangement includes at least one shape-memory element 20 formed from shape-memory alloy and configured such that, when a temperature of the shape-memory element is raised above a transition temperature, shape-memory element 20 undergoes a phase change so as to become biased towards a predefined spring configuration, illustrated here as a helical spring configuration, shaped and sized to apply force to piston 14.

Apparatus 10 also includes at least one flow-guide element 22 defining at least part of a flow path for the inflow of unpressurized hot water to chamber 12. Flow-guide element 22 at least partially blocks the inflow from reaching the shape-memory element until at least a majority of chamber 12 has been filled. This ensures that the inflow of hot water is effective to sequentially fill the chamber and then heat the shape-memory element above the transition temperature.

At this point, it will already be appreciated that the present invention provides profound advantages. Specifically, by employing one or more flow-guide elements to ensure correct sequencing of hot water flow into chamber 12 and then sufficiently raising the temperature of shape-memory element 20 to achieve its phase change, a straight forward action of pouring an inflow of near-boiling unpressurized water is effective to fill the chamber and then operate the actuator arrangement to deliver hot water at a desired high pressure through ground coffee to produce espresso-type coffee beverage. This and other advantages of the present invention will be better understood with reference to the drawings and accompanying detailed description below.

Turning now to the features of apparatus 10 in more detail, the actuator arrangement preferably includes a housing 16 sealingly connected with chamber 12 such that, after filling of chamber 12, continuing inflow of hot water increases a water level within the housing until the shape-memory element is at least partially immersed in the hot water. Although an implementation in which heating of the shape-memory element 20 is achieved by steam and/or convection heating from water not coming in contact with the shape-memory element 20, the immersion approach is typically preferred as a quicker and more reliable manner of heating the shape-memory element.

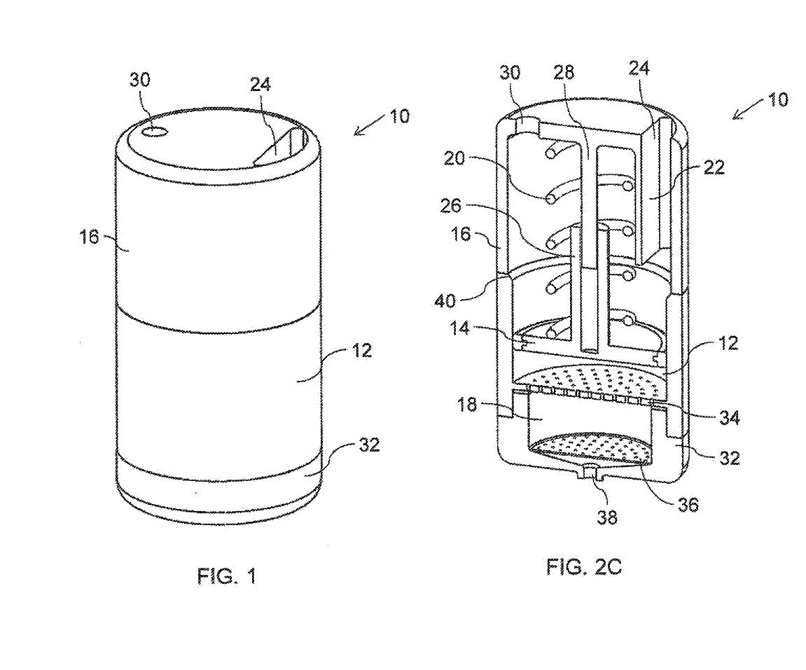

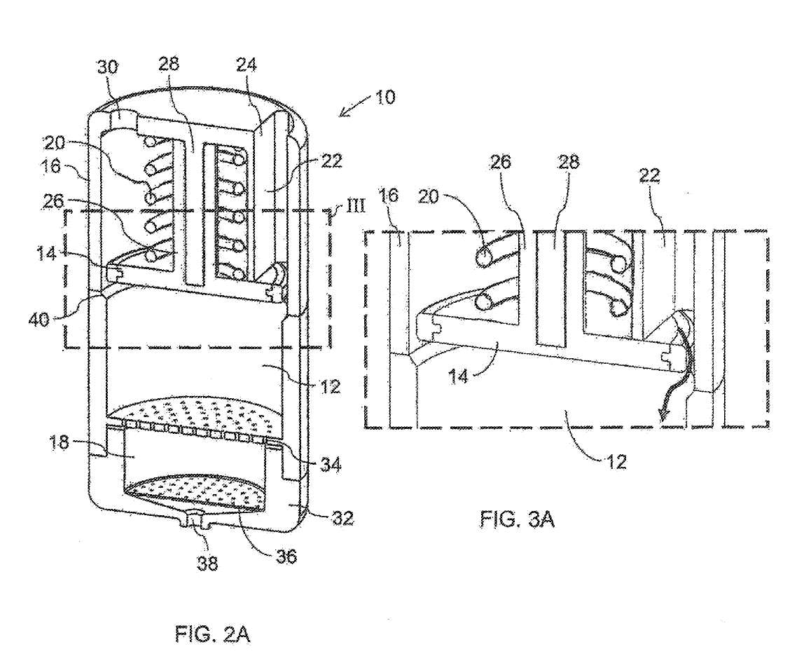

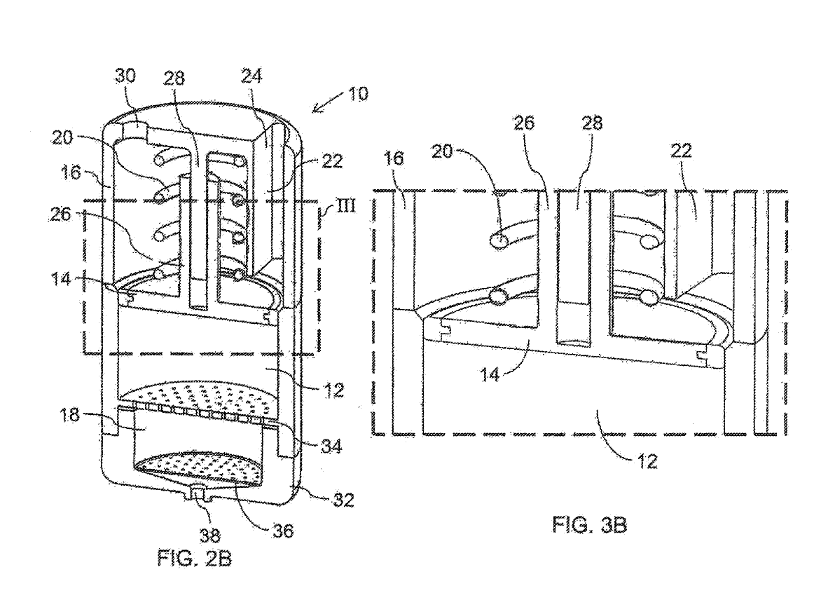

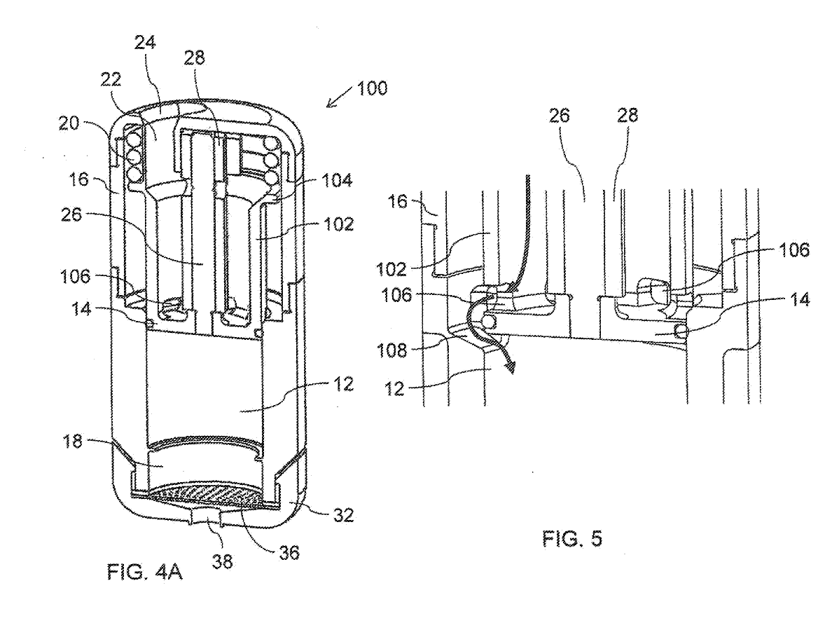

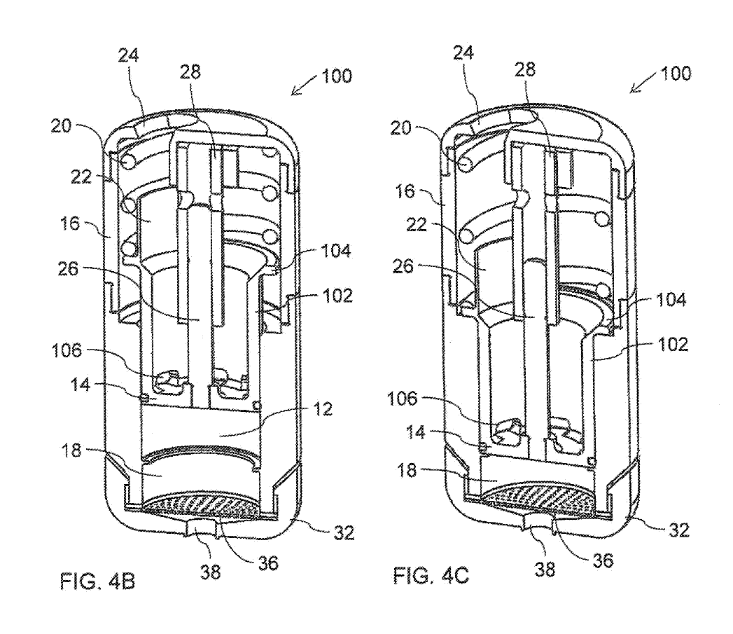

In the implementation shown here, flow-guide element 22 is implemented as a baffle formed integrally with housing 16 defining a flow path from a filling aperture 24 to adjacent piston 14. As shown in FIGS. 2A and 2B, an initial position of piston 14 is slightly raised above the main inner bore of chamber 12, thereby leaving a flow path (illustrated by an arrow in FIG. 3A) for the inflow of how water to flow around piston 14 to fill chamber 12. Alignment of piston 14 is preserved by a linear bearing, in this case formed by a hollow piston stem 26 which slides along a guide rod 28 which is integrated with housing 16. It will be noted that this configuration can readily be reversed to employ a solid piston stem 26 and a hollow guide 28, such as is illustrated in FIGS. 4A-4C below.

A lower casing 32 at least partially defines ground-coffee-receiving compartment 18, preferably delimited by an upper coffee filter 34 and a lower coffee filter 36, and a coffee outlet spout 38. Lower casing is preferably separable from chamber 12 so as to open the ground-coffee-receiving compartment for filling and cleaning. The compartment may receive loose ground coffee and/or capsules containing ground coffee. Where capsules are to be used, penetrating features (not shown) are preferably provided, for example on the inward-facing surfaces of upper and lower coffee filters 34 and 36, so as to perforate upper and lower sides of the capsule as the lower casing is closed. Sealed connection of lower casing 32 to chamber 12 may be achieved by any suitable connection, such as a threaded engagement or a bayonet engagement.

In use, after filling compartment 18 with the desired quantity of ground coffee, closing lower casing 32 and positioning apparatus 10 over a cup (such as by use of a suitable support bracket or stand, not shown), hot water is poured in through filling aperture 24 and is guided by flow-guide element 22 to the region of piston 14 where it flows through the gap around piston 14 to reach chamber 12. After chamber 12 is full, the water level continues to rise within housing 16 as more hot water is poured into the apparatus, thereby immersing shape-memory element 20. Air displaced from the apparatus by the inflow of water escapes via a vent hole 30 in the upper surface of housing 16, and/or via back along flow-guide element 22.

Shape-memory element 20 is heated by the hot water above its transition temperature, which is chosen by selection of suitable alloy composition to occur at a suitable temperature in the range of 30° C.-100° C., and most preferably in the range of 75° C.-95° C. On reaching its transition temperature, as a result of its phase change, shape-memory element 20 tries to revert to its predefined helical spring form, which has an unstressed length greater than required for the full displacement of piston 14, and therefore functions as a spring, applying a predefined force to piston 14, thereby forcing the piston downwards so that it comes into sealing engagement with the wall of chamber 12, applies pressure the quantity of water trapped below the piston. In addition to the alignment achieved by the linear bearing fanned by hollow piston stem 26 and guide rod 28, an inclined step 40 around the top of the cylindrical wall of chamber 12 helps ensure correct alignment of piston 14 to enter full engagement with the will of chamber 12. The force of shape-memory element 20 then forces the water from chamber 12 to pass under pressure through the ground coffee until it emerges from coffee outlet spout 38.

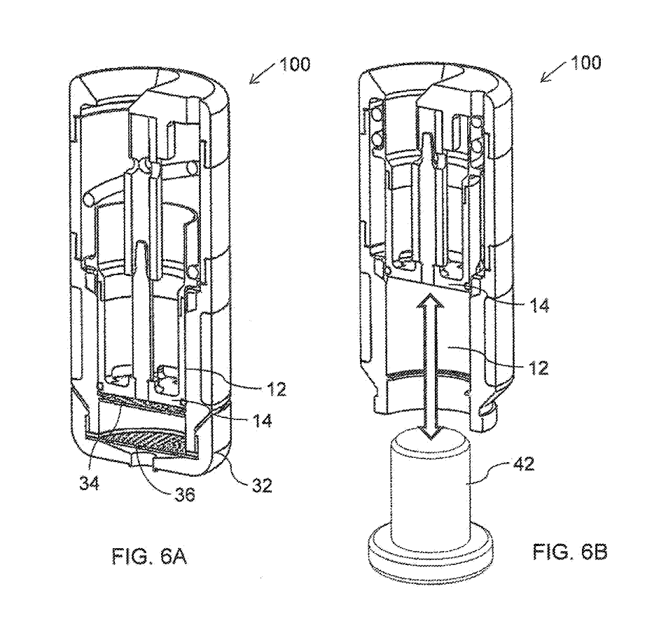

After use, excess hot water present in actuator housing 16 is tipped out, lower casing 32 is opened and any capsule is removed and discarded, and/or coffee grounds rinsed out. When shape-memory element 20 cools below its transition temperature, it undergoes a phase change which renders it deformable, ready for resetting to its initial compressed form, ready for next use. One preferred arrangement for resetting the apparatus is illustrated below in FIGS. 6A and 6B, where a plunger 42 is sized and shaped such that, after operation of the apparatus, when the shape-memory element has cooled below the transition temperature and when the ground-coffee-receiving compartment is opened and the filters (if any) are removed, forced insertion of plunger 42 into chamber 12 is effective to return shape-memory element 20 to its initial form, ready for re-use. (To avoid confusion, it should be noted that the other details of FIGS. 6A and 6B do not fully match the present embodiment.)

It should be noted that, although shown herein as a helical spring form, shape-memory element 20 may be implemented in a wide range of different spring forms including, but not limited to, one or more torsion springs, one or more leaf springs, and one or more beveled washers. Use of helical springs is particularly preferred due to the simplicity of manufacture of helical spring forms, and the simplicity of the corresponding apparatus structures as shown herein.

Turning now to the remaining exemplary embodiments of the present invention, these all share common principles of operation and many corresponding components. Accordingly, components equivalent to corresponding components of apparatus 10 are labeled similarly to the reference numerals used above, and the structure and function of such components should be understood by reference to the above description, unless clearly indicated otherwise.

Turning now to FIGS, 4A-5, these illustrate an apparatus, generally designated 100, constructed and operative according to a further embodiment of the present invention. Apparatus 100 is similar in structure and function to apparatus 10 described above, with similar elements being labeled similarly. Apparatus 100 differs from apparatus 10 primarily in the arrangement of the components of the actuator mechanism and the form of the flow path.

Specifically, in the embodiment illustrated here, shape-memory element 20 has a helical spring form of relatively large diameter deployed adjacent to a cylindrical inner surface of actuator housing 16, while flow-guide element 22 at least partially defines a flow path passing within the axially compressed helical form. In the case illustrated here, flow-guide element 22 is integrated with piston 14 and includes a wall 102 circumscribing at least part of the flow path. A radially projecting flange 104 provides an abutment surface against which the helical spring of shape-memory element 20 bears when heated.

As a result of this structure, the flow path for inflow of hot water from filling aperture 24 passes within the volume of the piston assembly. In order to reach chamber 12, the flow path through the body terminates in at least one opening 106 adjacent to a seal of piston 14.

An additional feature, best seen in FIG. 5, relates to provision of bypass flow channels in the wall of chamber 12. Specifically, chamber 12 is partly defined by a cylindrical wall against which piston 14 is slidingly engaged. A first region of the cylindrical wall is here provided with one or more bypass flow-channels 108 configured such that, when piston 14 is engaged with the cylindrical wall in an initial position, bypass flow-channels 108 provide part of the flow path bypassing piston 14 for inflow of the hot water into chamber 12. This arrangement, as an alternative to the all-around clearance of the piston of apparatus 10, ensures that piston is reliably engaged and aligned with the wall of chamber 12 at all positions in its range of motion.

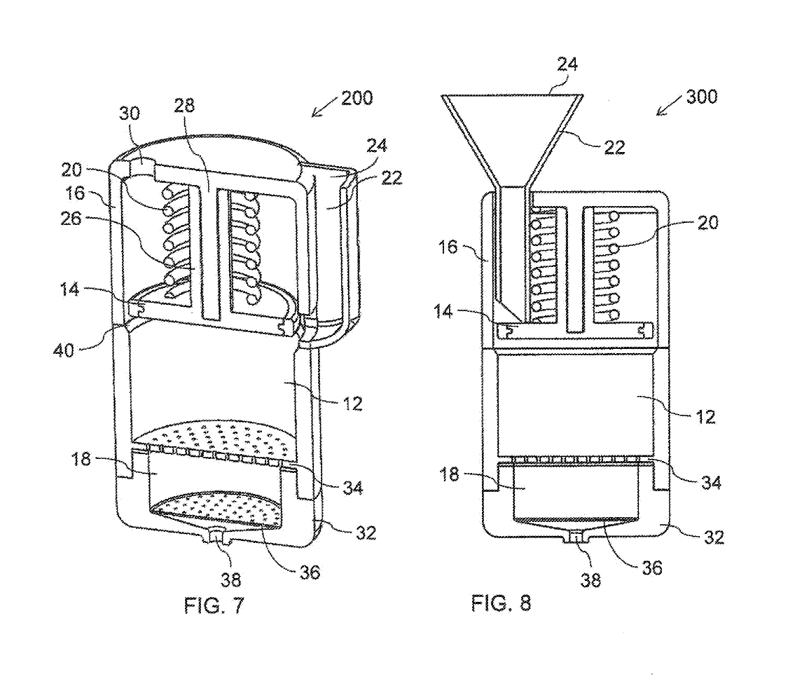

Turning now to FIG. 7, this illustrates an apparatus, generally designated 200, constructed and operative according to a further embodiment of the present invention. Apparatus 200 is similar in structure and function to apparatus 10 described above, with similar elements being labeled similarly. Apparatus 200 differs from apparatus 10 primarily in that flow-guide clement 22 is here implemented as an external chute integrated with an external surface of actuator housing 16 that directs an inflow of hot water directly to the region at, or just above, piston 14. In all other respects, the structure and function of apparatus 200 is equivalent to that of apparatus 10 described above.

Turning now to FIG. 8, this illustrates an apparatus, generally designated 300, constructed and operative according to a further embodiment of the present invention. Apparatus 300 is similar in structure and function to apparatus 10 described above, with similar elements being labeled similarly. Apparatus 300 differs from apparatus 10 primarily in that flow-guide element 22 is here implemented as a removable flow guide or funnel, insertable into an opening 302 in the top of actuator housing 16. In all other respects, the structure and function of apparatus 200 is equivalent to that of apparatus 10 described above.

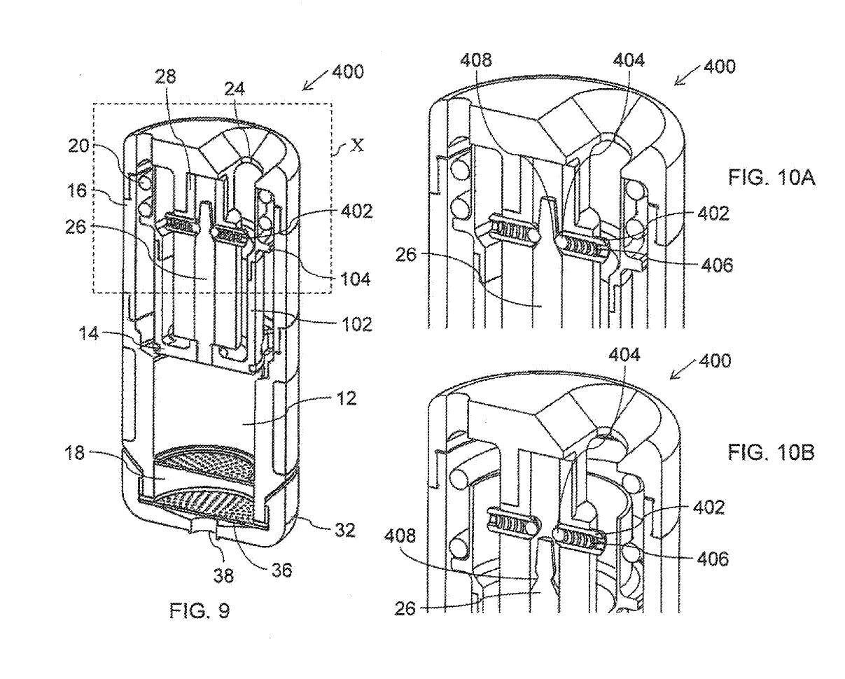

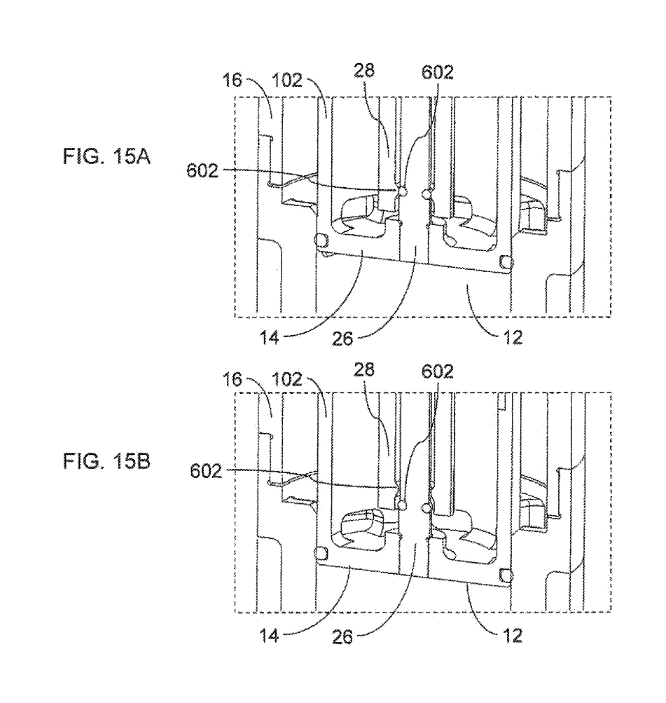

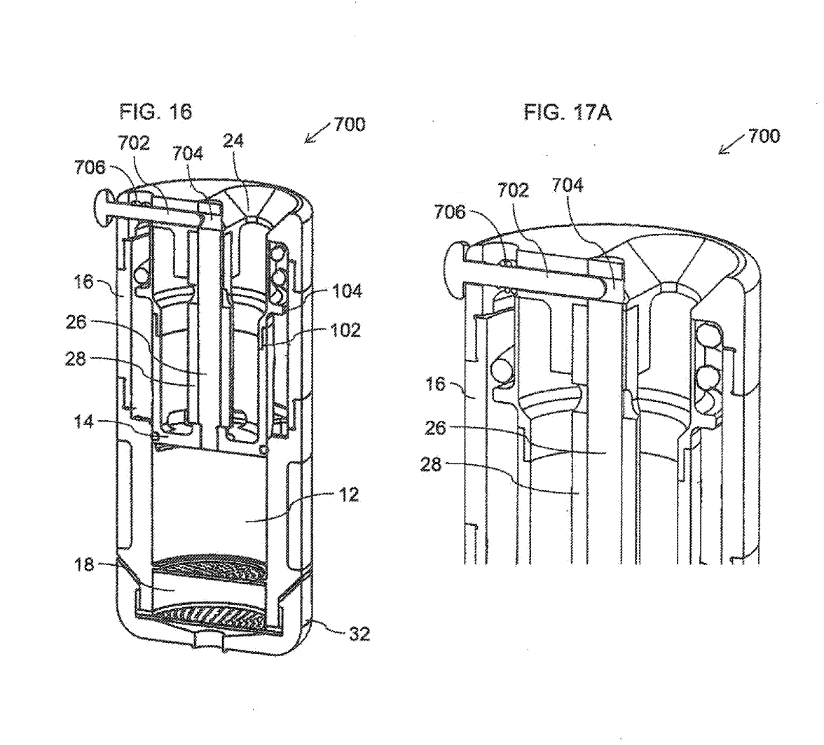

Turning now to FIGS. 9-18C. these illustrate a number of variants of apparatus 100 which illustrate various implementations of a retaining mechanism to prevent premature movement of piston 14 along chamber 12. In a first subset of these implementations (FIGS. 9-15B), the apparatus includes a resilient obstruction associated with piston 14 and with housing 16 which is deployed to prevent motion of piston 14 relative, to chamber 12 until a force exerted by the actuator arrangement exceeds a predefined force threshold. In an alternative set of implementations (FIGS. 16-18C), positive engagement of a locking pin is used to prevent premature motion of the piston.

The various retaining mechanisms disclosed herein may perform one or both of two functions. In the case where the mechanism is released by application of a relatively low-threshold force, the retaining mechanism may be used to ensure that any residual elasticity in the room-temperature state of shape-memory element 20 does not cause piston 14 to be displaced prior to use, and allows a relatively strong spring configuration to be assembled in as compact a configuration as possible for its pre-actuation state. In the case of a higher force threshold for release, the mechanism may play an additional role by ensuring that piston motion does not begin until at least a majority of shape-memory element 20 has undergone its phase change, thereby ensuring that a desired minimum pressure threshold is achieved in chamber 12 from near the beginning of the piston motion.

Turning now to FIGS. 9-10B, these illustrate an apparatus, generally designated 400, constructed and operative according to a further embodiment of the present invention. Apparatus 400 is similar in structure and function to apparatus 100 described above, with similar elements being labeled similarly. In this case, an increased thickness guide 28 supports one or more spring-mounted bearing assemblies 402, also known as “ball plungers”, in which a bearing 404 is biased by a spring 406 radially inwards against a corresponding notch 408 cut into piston stem 26. The force threshold required to release the piston for motion can readily be designed by choice of the design-load of the ball plunger and by the shape and depth of notch 408.

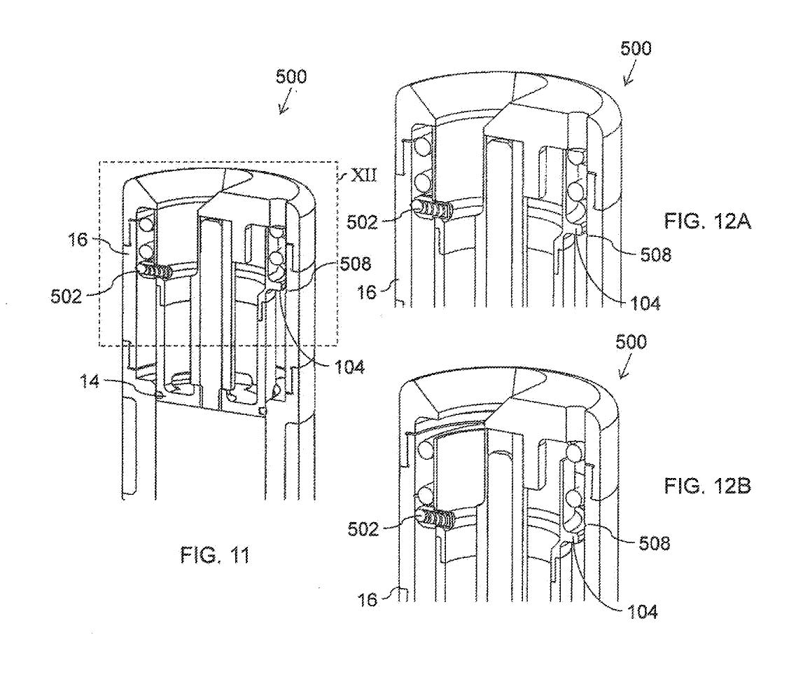

FIGS. 11-12B show an apparatus 500, similar to apparatus 400, in which ball plungers are mounted so as to move together with piston 14, and engage a notch formed in housing 16. Specifically, ball plunger 502 is here mounted in radial flange 104 so as to bear radially outwards to engage a corresponding notch 508 cut into an inner wall of housing 16. Here too, the force threshold required to release the piston for motion can readily be designed by choice of the design-load of the ball plunger and by the shape and depth of notch 508.

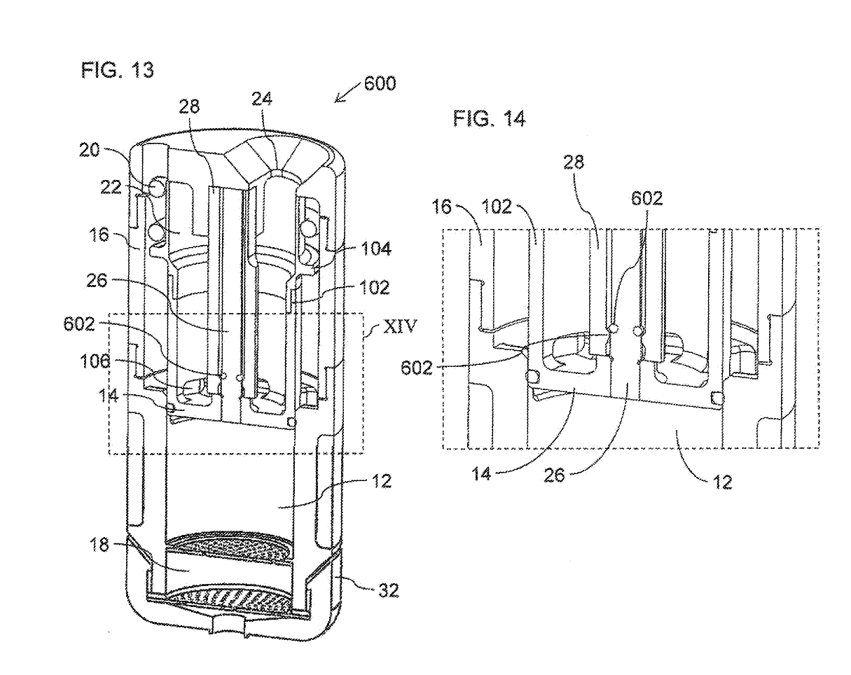

Turning now to FIGS. 13-15B, these illustrate an apparatus 600, constructed and operative according to a further embodiment of the present invention. Apparatus 600 is similar in structure and function to apparatus 100 described above, with similar elements being labeled similarly. In this ease, a retaining mechanism is implemented as a resilient obstruction formed by an elastomeric element 602 deployed adjacent to a restriction 604 such that displacement of piston 14 relative to chamber 12 is prevented until elastomeric element 602 is deformed sufficiently to pass restriction 604. In the case illustrated here, elastomeric element 602 is implemented as an O-ring deployed in a slot, around piston stem 26, and restriction 604 is implemented as a locally narrowed ridge on the internal surface of hollow guide 28. Here too, a desired force threshold required to overcome this resistance can be achieved by suitable design of the dimensions and choice of material for elastomeric element 602, as well as of the dimensions and rise-angle of restriction 604. Preferably, a rise angle of the restriction in the reverse (reset) direction is a lower angle so as to facilitate manual resetting of the piston and actuator arrangement to their starting positions, as described above.

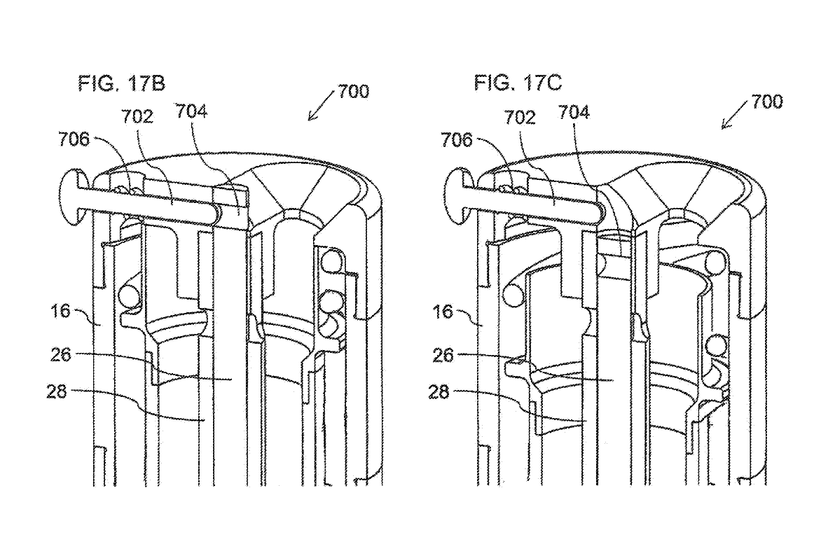

Turning now to FIGS. 16-17C, these illustrate an apparatus 700, constructed and operative according to a further embodiment of the present invention. Apparatus 700 is similar in structure and function to apparatus 100 described above, with similar elements being labeled similarly. In this case, a retaining mechanism is implemented using a locking pin 702 engaged with the piston and with housing 16 of the actuator arrangement so as to prevent premature motion of piston 14 relative to chamber 12. Locking pin 702 is displaceable to release engagement with piston 14 (or in an alternative configuration not shown, with housing 16) to allow motion of piston 14 relative to chamber 12. In the implementation shown here, locking pin 702 is mounted in the top of housing 16, and a tip of the pin engages a corresponding bore or recess 704 formed in piston stem 26.

In a particularly preferred implementation as illustrated here, a shape-memory alloy trigger element, here implemented as a small helical spring 706, is associated with locking pin 702 and is configured to displace the locking when the shape-memory alloy trigger element is raised above a given trigger temperature. Depending upon the desired function of the trigger element, the trigger temperature, i.e., the shape-memory phase change transition temperature for the trigger element, may be chosen to be different from that of the main shape-memory element 20. Specifically, if it is desired that the retaining mechanism perform only the pre-actuation function of maintaining the compact state of element 20 prior to use, the trigger temperature may be chosen to be lower than the transition temperature of element 20 such that, during the initial stages of filling the apparatus with hot water, the heat from steam and/or convection from the water is sufficient to release the actuator mechanism before element 20 reaches its transition temperature. Alternatively, if the trigger temperature is chosen to be similar to (or higher than) the transition temperature of element 20, the preferred positioning of the trigger element at the top of housing 16 will typically ensure that the retaining mechanism is not released until most, if not the entirety, of element 20 has been heated to a temperature above its transition temperature, thereby ensuring application of sufficient force to develop a desired pressure within chamber 12.

In all other respects, the structure and function of apparatuses 400, 500, 600 and 700 are fully analogous to that of apparatuses 10 and 100 described above, and will be understood by reference and analogy to the description of those apparatuses.

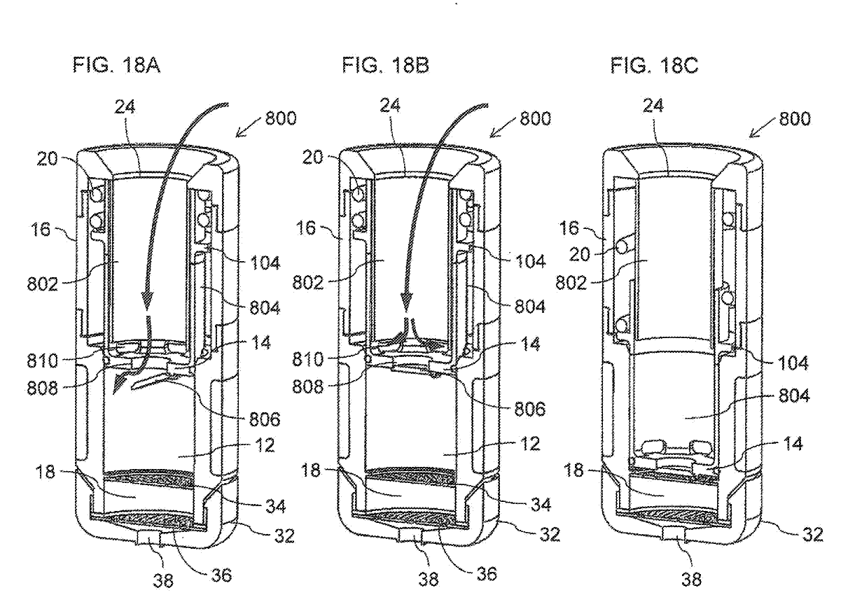

Turning finally to FIGS. 18A-18C, these illustrate an apparatus, generally designated 800, constructed and operative according to a further embodiment of the present invention. Apparatus 800 is similar in structure and function to apparatus 100 described above, with similar elements being labeled similarly. Apparatus 800 differs from apparatus 100 primarily in the arrangement of the actuator mechanism and piston in a manner to generate a large central filling aperture 24.

Specifically, in the embodiment illustrated here, in addition to engagement with the cylindrical wall of chamber 12, piston 14 is supported by an inner cylinder 802 which is in sliding engagement with a cylindrical wall 804 integrated with piston 14. Cylinder 802 and wall 804 may each be considered a flow-guide element 22 according to this embodiment. This configuration leaves a large central filling aperture which is believed to be particularly convenient for use.

While this embodiment could be implemented with a flow path similar to that illustrated in FIG. 5 above, certain particularly preferred embodiments employ a check valve formed in piston 14 to allow inflow of hot water directly into chamber 12, as illustrated by arrows in FIG. 12A. The check valve is preferably implemented with a valve flap 806 closing a piston aperture 808, and is typically biased to its closed state by a spring (not shown).

During inflow of hot water, the weight of the water opens the check valve until chamber 12 is full. Valve flap 806 then closes, under action of the spring and/or flotation, and the inflow of hot water starts to distribute inside and outside cylinder 802 by outward flow via apertures 810, thereby gradually immersing and heating shape-memory element 20, leading to actuation of the apparatus, all as described above.

In all other respects, the structure and function of apparatus 800 is fully analogous to that of apparatuses 10 and 100 described above, and will be understood by reference and analogy to the description of those apparatuses.

It will be appreciated that the above descriptions are intended only to serve as examples, and that many other embodiments are possible within the scope of the present invention as defined in the appended claims.

What is claimed is:

1. An apparatus receiving an inflow of unpressurized hot water and generating a pressurized flow of a quantity of the hot water through ground coffee, the apparatus comprising:
(a) a chamber for receiving the quantity of hot water;
(b) a piston configured to cooperate with the chamber to apply pressure to the quantity of hot water;
(c) an actuator arrangement for forcing said piston through at least part of said chamber so as to deliver the quantity of hot water under pressure through the ground coffee, said actuator arrangement comprising at least one shape-memory element formed from shape-memory alloy and configured such that, when a temperature of said shape-memory element is raised above a transition temperature, said shape-memory element undergoes a phase change so as to become biased towards a predefined spring configuration, thereby applying force to said piston; and
(d) at least one flow-guide element defining at least part of a flow path for the inflow of unpressurized hot water to said chamber, said flow-guide elements at least partially blocking the inflow from reaching said shape memory element until at least a majority of said chamber has been filled,
such that the inflow of hot water is effective to sequentially fill said chamber and then heat said shape-memory element above said transition temperature.

2. The apparatus of claim 1, wherein said actuator arrangement includes a housing sealingly connected with said chamber such that, after filling of said chamber, continuing inflow of the hot water increases a water level within said housing until said shape-memory element is at least partially immersed in the hot water.

3. The apparatus of claim 1, further comprising a selectively openable ground-coffee-receiving compartment associated with an end of said chamber, said ground-coffee-receiving compartment being in fluid flow communication with said chamber for receiving the pressurized flow of the quantity of hot water.

4. The apparatus of claim 3, further comprising a plunger sized and shaped such that, after operation of the apparatus, when said shape-memory element has cooled below said transition temperature and when said ground-coffee-receiving compartment is opened, forced insertion of said plunger into said chamber is effective to return said shape-memory element to an initial form.

5. The apparatus of claim 1, wherein said predefined spring configuration of said shape-memory element is a helical spring form, and wherein, in an initial form of said shape-memory element prior to said phase change, said helical spring form is axially compressed, said flow-guide element at least partially defining a flow path passing within said axially compressed helical form.

6. The apparatus of claim 5, wherein said piston has an elongated body including said flow-guide element implemented as a wall circumscribing at least part of said flow path.

7. The apparatus of claim 6, wherein said piston has a seal for sealing in sliding contact with a cylindrical surface of said chamber, and wherein said flow path through said body terminates in at least one opening adjacent to said seal.

8. The apparatus of claim 1, wherein said chamber is partly defined by a cylindrical wall against which said piston is slidingly engaged, and wherein a first region of said cylindrical wall is provided with at least one bypass flow-channel configured such that, when said piston is engaged with said cylindrical wall in an initial position, said bypass flow-channel provides part of said flow path bypassing said piston for inflow of the hot water into said chamber.

9. The apparatus of claim 1, further comprising a resilient obstruction associated with said piston and with a housing of said actuator arrangement, said resilient obstruction being deployed to prevent motion of said piston relative to said chamber until a force exerted by said actuator arrangement exceeds a predefined force threshold.

10. The apparatus of claim 9, wherein said resilient, obstruction comprises an elastomeric element deployed adjacent to a restriction such that displacement of said piston relative to said chamber is prevented until said elastomeric element is deformed sufficiently to pass said restriction.

11. The apparatus of claim 9, wherein said resilient obstruction comprises at least one spring-mounted bearing assembly.

12. The apparatus of claim 1, further comprising a locking pin engaged with said piston and with a housing of said actuator arrangement so as to prevent motion of said piston relative to said chamber, said locking pin being displaceable to release engagement with one of said piston and said housing to allow motion of said piston relative to said chamber.

13. The apparatus of claim 12, further comprising a shape-memory alloy trigger element associated with said locking pin and configured to displace said locking when said shape-memory alloy trigger is raised above a given trigger temperature.
